(19) United States
(12) Patent Application Publication
(10) Pub. No.: US 2009/0149184 A1
(43) Pub. Date: Jun. 11, 2009

(54) LOAD BALANCING BY TERMINAL TYING

(75) Inventors: Thomas Hohne, Helsinki (FI); Petri Jolma, Nurmijaervi (FI); Jani Moilanen, Helsinki (FI); Lauri Kuru, Espoo (FI); Zekeriya Uykan, Espoo (FI); He Xiaoben, Espoo (FI)

Correspondence Address: BRAKE HUGHES BELLERMANN LLP, c/o CPA Global, P.O. BOX 52050, MINNEAPOLIS, MN, 55402, US

(73) Assignee: Nokia Corporation, Espoo (FI)

(21) Appl. No.: 12/110,791

(22) Filed: Apr. 28, 2008

(30) Foreign Application Priority Data
Dec. 7, 2007 (EP) 07023783.9

(51) Int. Cl. H04Q 7/20

(52) U.S. Cl. 455/437; 455/436; 455/440; 455/443

(57) ABSTRACT

Example embodiments of methods, computer program products, apparatus, and systems for controlling handover of a terminal device are disclosed. In an example system, a terminal device is configured to select a handover target and initiate handover on its own. In the example system, the terminal device is tied to at least one predetermined cell by performing network-sided control of available handover targets.

### CROSS-REFERENCE TO RELATED APPLICATIONS

This application claims priority to European Patent Application Serial Number 07 023 783.9 EP, filed on Dec. 7, 2007, entitled “Load Balancing by Terminal Tying,” which is hereby incorporated by reference.

### FIELD

The present disclosure relates to methods, systems, apparatus, and computer program products for balancing network load by controlling handover operations of radio resource management in mobile networks, such as—but not limited to—the Worldwide Interoperability for Microwave Access (WIMAX) network.

### BACKGROUND

WiMAX makes possible new advances in radio technology High spectral efficiency, achieved through adaptive modulation and advanced coding schemes, allows optimized trade-off between throughput and coverage. WIMAX chipsets integrated into laptops and other portable IP (Internet Protocol) devices will provide high-speed [P services to users on the move, extending today's public wireless local area network (WLAN) hotspot coverage and delivering broadband services everywhere outside the subscriber's home. The user may thus access applications through the best available network.

A mobile version of WiMAX, as specified in IEEE (Institute of Electrical and Electronics Engineers) specification 802.16e-2005, will soon begin to enter the commercial mainstream. The IEEE 802.16e-2005 standard defines a framework for supporting mobility management. In particular, the standard defines signaling mechanisms for tracking subscriber stations as they move from the coverage range of one base station to another when active or as they move from one paging group to another when idle. The standard also has protocols to enable a seamless handover of ongoing connections from one base station to another. A mandatory handoff method supported in IEEE 802.16e-2005 is called hard handover (HHO) and is the only type required to be implemented by mobile WiMAX initially. HHO implies an abrupt transfer of connection from one base station (BS) to another. Handover decisions are made on the based of measurement results reported by the concerned mobile receive and transmit unit or mobile terminal, e.g., user equipment (LJE), or mobile station (MS). The mobile terminal periodically does a radio frequency (RF) scan and measures the signal quality of neighboring base stations. Scanning is performed during scanning intervals allocated by a serving base station (BS). During these intervals, the mobile terminal is also allowed to optionally perform initial ranging and to associate with one or more neighboring base stations. Once a handover decision is made by the mobile terminal, it begins synchronization with the downlink transmission of the target BS, performs ranging if it was not done while scanning, and then terminates the connection with the previous BS. Any undelivered packet data units at the previous BS are retained until a timer expires.

In addition to the above HHO procedure, two optional handover methods are supported in IEEE 802.16e-2005, namely fast base station switching (FBSS) and macro diversity handover (MIDHO). In these two methods, the mobile terminal maintains a valid connection simultaneously with more than one BS. In the FBSS case, the mobile terminal maintains a list of the BSs involved, called the active set. The mobile terminal continuously monitors the active set, does ranging, and maintains a valid connection identity (ID) with each of them. The mobile station, however, communicates with only one BS, called the anchor BS. When a change of anchor BS is required, the connection is switched from one base station to another without having to explicitly perform handoff signaling. The mobile station simply reports the selected anchor BS on a fast feedback channel called channel quality information channel (CQICH). Macro diversity handover is similar to FBSS, except that the mobile terminal communicates on the downlink and the uplink with all the base stations in the active set—called a diversity set here—simultaneously. In the downlink, multiple copies received at the mobile terminal are combined using any of the well-known diversity-combining techniques. In the uplink, where the mobile terminal sends data to multiple base stations, selection diversity is performed to pick the best uplink.

However, in cellular systems, such as WiMAX, where the final choice of the cell to use is left with the mobile terminal, a situation may arise where from the network perspective the mobile terminal should be served by a cell which it would not choose by itself. E.g., assuming a scenario where lower frequency reuse is provided close to the BS and higher farther away. While a mobile terminal close to the BS could well survive with the lower power of a smaller cell, it would naturally choose the larger cell due to the higher power thereof. This may not be desirable from the network capacity point of view.

### SUMMARY

According to various embodiments, a method is provided, which may include controlling handover of a terminal device in a cellular network in a manner so that said terminal device is configured to select a handover target and initiate handover on its own. The method may also include tying said terminal device to at least one predetermined cell by performing network-sided control of available handover targets.

Additionally, according to various embodiments, an apparatus may include a handover controller configured to generate a network-sided control signaling for controlling handover targets available to a terminal device of a cellular network, so as to tie said terminal device to at least one predetermined cell.

Further, a system may include at least one apparatus as defined above, and at least one terminal device configured to make the final decision about a handover target.

Moreover, a computer program product may include code for producing the steps of the above method when run or executed on a computer device.

Accordingly, once it is clear which cell should serve the terminal device, the access devices (e.g. base stations) of the non-tied cells (e.g. larger cells) in the neighborhood or proximity can be made non-available for the terminal device. In this way a terminal device can be directed to a certain cell and the load between cells can be balanced in a fashion favorable for the network capacity.

No amendment to the standard is required, if the neighboring access devices are offered by the same vendor (as they typically are). If a neighboring access device does not understand the message or control signaling issued by the network-sided control functionality, the network remains operational. An eventually increased HO activity can be offset by the improved interference performance of the cell.

Non-availability of undesirable target cells or access devices can be achieved by notifying access devices of the at least one tied cell to refuse HO requests by the concerned terminal device. Thus, the network-sided control can be performed by controlling at least one neighboring handover target device located in the neighborhood or proximity of an access device currently serving the terminal device, so that the at least one neighboring handover target device rejects a handover request from the terminal device. A target device which serves target cells of a cell size larger then a desired cell size could be selected as the at least one neighboring handover target device.

In a specific example, the network-sided control may be performed by sending a handover command to the terminal device and by instructing the at least one neighboring handover target device not to accept the terminal device. Instructing may, for example, be done by distributing a tying message indicating at least one tied terminal device which should be served by a predetermined cell. Additionally, the network-sided control may be performed by sending an end-of-tying message which indicates that tying of at least one tied terminal has ended.

According to an embodiment, network-sided control may be performed by predicting at least one of signal strength and signal quality for a hypothetical case that said terminal device is served by a smaller cell, and by deciding about handover based on a threshold criterion. This threshold criterion may, for example, be based on a hysteresis where a first threshold for admitting the terminal device is lower than a second threshold for releasing the terminal device.

As an additional option, the decision about the handover may be based on a location information of the terminal device.

In case a handover has not been successful after a predetermined time period, the tying could be removed so as to make all potential handover targets available for the terminal device.

In case of at least two overlapping serving cells, the network-sided control may be performed by selecting an optimal tying cell from the at least two overlapping cells.

As an additional or alternative option, non-availability of undesirable target cells or access devices can be achieved by not advertising any neighboring access devices (e.g. empty list, or list containing only an ID of the own access device) to the terminal device. Once the terminal device is being served by a desirable cell (e.g. a desired smaller cell), the serving access device may ask the terminal device to report the downlink channel quality relatively frequently. The terminal device may then be provided with the real or full list of neighboring access devices if the link quality gets poor (as defined by measurement variable(s), e.g. Carrier to Interference and Noise ratio (CINR) and/or Receive Signal Strength Indicator (RSSI)) between the terminal device and the desired access device.

Thus, network-sided control is achieved by advertising a reduced or empty list of neighboring access devices to the terminal device. The limited or restricted advertisement may be performed as long as a determined link quality is sufficient (e.g., link quality is above a first threshold), while a full list of neighboring access devices may be advertised if the determined link quality falls below a second predetermined threshold. The required link quality may be determined based on a measurement result received from the terminal device.

Additionally, network-sided control may be performed by allocating a scanning time to the terminal device for scanning neighboring access devices, and by setting the duration of the scanning time in dependence on a determined link quality at the terminal device. Then, the scanning time may be set to zero if the link quality exceeds a predetermined threshold.

Further modifications or developments are defined in the dependent claims.

### BRIEF DESCRIPTION OF THE DRAWINGS

Example embodiments will now be described with reference to the accompanying drawings in which:

FIG. 1 shows a schematic block diagram of a cellular system with an exemplary scenario in which example embodiments can be implemented;

FIG. 2 shows a schematic block diagram of an apparatus according to an embodiment;

FIG. 3 shows a signaling diagram of a handover control method according to an embodiment;

FIG. 4 shows a signaling diagram of a handover control method according to an another embodiment; and

FIG. 5 shows a schematic block diagram of a software-based implementation of the embodiment.

### DETAILED DESCRIPTION

In the following, exemplary embodiments will be described based on a WiMAX system. However, it will be apparent from the following description and is therefore explicitly stressed that the present invention can be applied to any other mobile network system which involves terminal devices configured to select a handover target (HO) and initiate handover on its own, e.g., so as to make final HO decisions.

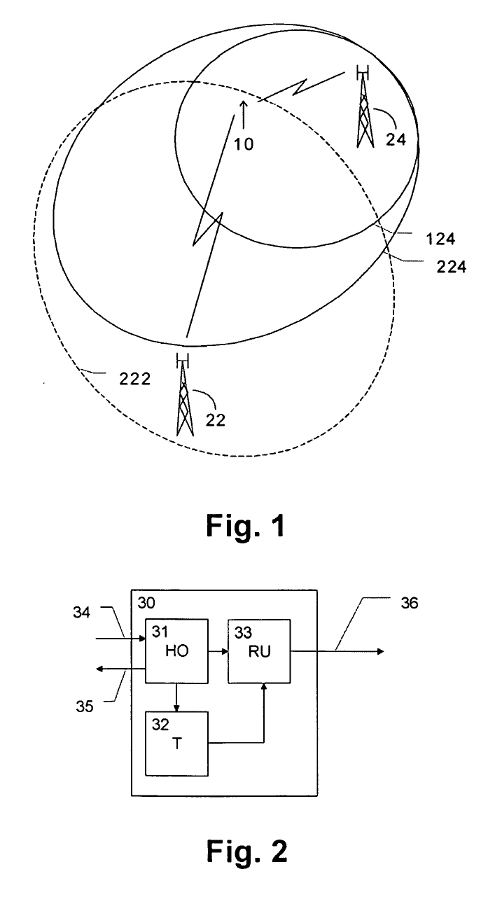

FIG. 1 shows a schematic block diagram of a cellular system with an exemplary scenario in which the present invention can be implemented.

A terminal device or mobile station (MS) 10 is currently served by a base station (BS) 24 which is configured to provide a larger cell 224 with larger cell size and a smaller cell 124 with a smaller cell size. In the scenario depicted in FIG. 1, the MS 10 is in the coverage area of both the larger and smaller cells 224, 124 and is very likely to select the larger cell 224 due to its higher power level. Additionally, a neighboring BS 22 is shown which provides a neighboring cell 222 with a large cell size, wherein the MS 10 is also located within the coverage area of the neighboring cell 222 of the neighboring BS 22.

According to a first embodiment, HO control is performed at the network side, e.g. by the serving BS 24 or a separate HO control unit (not shown) in a manner so that, once it is clear that the smaller cell 124 of the serving BS 24 should serve the MS 10, the BSs (e.g., BS 22) of larger cells (e.g., neighboring cell 222) in the (immediate) neighborhood or proximity of the serving BS 24 are told to refuse HO requests by that MS 10. In this way, the MS 10 can be directed to a certain cell and the load between cells can be balanced in a fashion favourable for the network capacity.

FIG. 2 shows a schematic block diagram of a HO control functionality or apparatus 30 according to an embodiment. The HO control functionality or apparatus 30 may be implemented as an integrated circuit, a chip set, a module, a software-controlled processing or computing device, or a hardware circuit, which can be provided at a BS (e.g., BSs 22 and/or 24 of FIG. 1) or any other suitable network device responsible for resource management, load balancing and/or HO control.

According to FIG. 2, the HO control functionality or apparatus 30 comprises a HO control function or control unit or controller 31 configured to decide about HO and/or tying of a served mobile terminal, e.g. MS 10 of FIG. 1, in dependence on specific parameters and/or information received or derived from the network and/or the served terminal device. The HO controller 31 is configured to control a reporting unit 33 to distribute or advertise messages, tying reports or instructions 36 to the network in order to control available HO targets. Additionally, an optional timer function or unit 32 may be provided for time-based control of HO or tying operations.

Assuming the MS 10 of FIG. 1 starts off in the larger cell 224, a decision is made by the HO controller 3 I of the HO control functionality or apparatus 30—which may be arranged at the BS 24 or at a separate and/or central HO control function in the network (not shown in FIG. 1)—to direct the MS 10 to the smaller cell 124. To achieve this, the HO controller 31 responsible for the larger cell 224 commands the MS 10 to perform a handover, and at the same time sends instructions 36 to surrounding large cells not to accept the MS 10. Assuming the MS 10 is served by the smaller cell's BS 24, it takes the initiative of informing or keeping surrounding BSs (e.g., the neighboring BS 22) informed about its tying of the MS 10 to itself, i.e. it signals that it wants to indirectly forbid the MS 10 to register with another BS. In the architecture of FIG. 1 it is assumed that the smaller cell 124 and the larger cell 224 are both served by the same BS 24. As an alternative option, the smaller and larger cells 124, 224 may be served by different base stations using a single antenna or different antennas and located close together.

In particular the above information distribution can be implemented by defining a message which tells which MS should be served by a first cell. The message is distributed to the tying cell's neighbors. The message content can be a list of tied MSs. The tying ends with a message originating from the first cell indicating the end of the tying. The tying may also end if another cell wants to tie the concerned MS (as for example directed by another HO control function).

At this point, it is noted that the functionalities of blocks 31 to 33 of FIG. 2 can be implemented as discrete hardware or signal processing units, or alternatively as software routines or programs controlling a processor or computer device to perform the processing steps of the above functionalities.

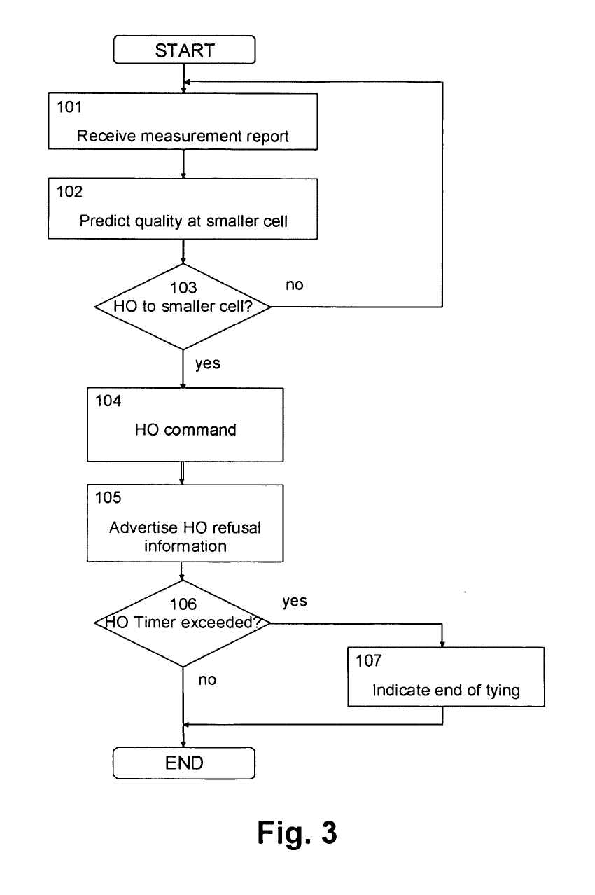

FIG. 3 shows a flow diagram of a HO control procedure according an embodiment, which may be executed by the HO controller 31 of FIG. 2. Based on this procedure it can be decided for example that the smaller cell's BS 24 becomes the serving BS.

Initially, it is assumed that the MS 10 is served by the larger cell 224. In block 101 the serving BS 24 receives a measurement report which has been sent by the MS 10 to report quality parameters such as signal strength and signal to interference plus noise ratio (SINR) values. The MS 10 may have been asked in advance to report downlink (DL) channel quality. Based oil the received quality information provided in the measurement report, the serving BS 24 predicts in block 102 signal strength and SINR values if the MS 10 were served by the smaller cell 124, and makes a HO decision in block 104 whether or not to hold or tie the MS 10 to the smaller cell 124. The HO decision can be made according to some threshold criterion. The decision criterion to hold the MS 10 in the smaller cell 124 can have a hysteresis. That is, an admission threshold (which determines when the MS 10 is admitted to be served by a cell) is lower than a releasing threshold (which determines when the MS 10 is to be released by a cell). Thus, frequent HO may be avoided in cases of small fluctuations of HO parameters (e.g. signal strength, SINR value and/or other suitable parameters).

If HO to the smaller cell 124 is refused in block 103, the procedure jumps back to block 101 and waits for or requests a new measurement report, based on which steps S101 to S103 are repeated. If however HO to the smaller cell 124 is decided in block 103, the procedure continues with block 104 and a HO command is sent to the MS 10. In parallel or at the same time the HO controller 31 controls the reporting function or unit 33 to advertise a message 36 with a HO refusal information indicating that the MS 10 is tied to the smaller cell 124. Thereby, it can be achieved that the MS 10 cannot be handed over to another neighboring cell.

Even with the above mentioned channel measurement validation something can go wrong and MS 10 may not be able to HO to the desired cell and may even get dropped. Therefore a functionality could be added to recover from such an undesirable situation. One possibility would be to use the timer function or unit 32 of FIG. 2 to implement a HO timer. When the HO timer has exceeded (if HO fails and MS is dropped), the tie is removed. Thus, when the HO command is sent in block 104, the HO controller 31 may trigger the timer function or unit 32 to start the HO timer. Then, in block 106 it is checked whether the HO timer has exceeded, i.e. whether a predetermined HO time period has exceeded since the HO command. If the time period has exceeded, the reporting unit 33 is triggered in block 107 by the timer function or unit 32 or by the HO controller 31 to advertise a message 36 indicating end of tying. Thereby, since HO is deemed to not have been successful, all neighboring HO targets are made available again. Otherwise, if the timer has not exceeded prior to successful handover (which may be indicated by a handover acknowledgement), HO is deemed to have been successful and the procedure ends.

Optionally, for defining the link quality to the smaller cell's BS 24, the serving BS can use direct measurement results from MS 10, if they are available. Additionally and optionally location information of the MS 10 may be used for the decision, if available.

If three cells are overlapping, so as to give even finer granularity of the re-use factor, the decision making (e.g. HO control function or unit 32) will choose the optimal tying cell.

In an example embodiment, according to the IEEE 802.16e specification (WiMAX Mobility), specific messages are defined for communication from, to, or between MS and BS, respectively. A MS initiates the scanning process by transmitting a Scanning Interval Allocation Request (MOB_SCN-REQ). The serving BS responds to the scanning request with a Scanning Interval Allocation Response (MOB_SCN-RSP), which either grants or denies the request. In case of a positive HO decision, the serving BS and the MS notify each other. In a mobile-controlled HO the MS transmits a MS HO Request (MOB_MSHO-REQ) message to the serving BS. The serving BS responds with a BS HO Response (MOB_BSHO-RSP) message. The MS transmits the final HO Indication (MOB_HO-IND) message which indicates that it is about to perform the HO (or not). In a mobile-assisted HO, the serving BS requests HO by transmitting a BS HO Request (MOB_BSHO-REQ) message. The MS acknowledges with the MOB_HO-IND message.

Advising neighboring BSs to refuse HO requests from the MS may be necessary, or at least advantageous, in systems, such as WiMAX, where an MS is not mandated to follow a BS HO suggestion. For example, according to the IEEE standard 802.16e-2005 chapter 6.3.22.2.2, an MS required to conduct handover is not restricted to conducting handover to those BS included in the notifying message. In other words, the MS may attempt handover to a different BS that may or may not have been included in either the MOB_BSHO-REQ or MOB_BSHO-RSP messages. This implies that it is possible to force an MS to perform HO but the MS may choose the target BS as it will. This means that the present HO control procedure according to the above embodiment is useful if such an MS is to be forced to HO to a certain BS.

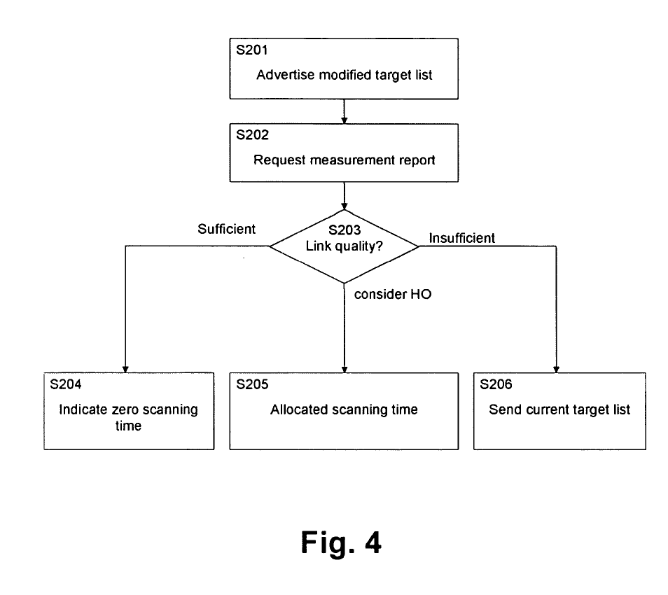

FIG. 4 shows a flow diagram of an alternative or additional HO control procedure according another embodiment, which may be executed by the HO controller 31 of FIG. 2. Based on this procedure it can also be decided for example that the smaller cell's BS 24 becomes the serving BS.

When the MS 10 is being served by the desired smaller cell 124, the serving BS 24 shall not advertise neighboring BSs (e.g. empty HO target list, or target list containing only it's own BS ID), or at least only a restricted number of HO targets. However, the MS 10 is (again) provided with a real or full list of HO targets (e.g. neighboring BSs) when the link quality gets poor (as defined by measurement variable(s), e.g. CINR and/or RSSI) between the MS 10 and smaller cell's BS 24.

Again, the HO controller 31 can be located in any network element. Typically this would be a BS, an access service network gateway (ASN-GW, which is a network node to which a BS connects in WIMAX systems) or a node which is dedicated to radio resource management and/or HO controlling.

According to FIG. 4, when the MS 10 of FIG. 1 is handed over to the smaller cell 124, the HO controller 31 at the smaller cell's BS 24 advertises in block 201 a modified target list (e.g. an empty target list) on the broadcast channel (for all MSs). Then, in block 202, it asks for CQICH (DL channel quality) measurement reports from each MS to keep track of the link. As an example, such reports may be provided every 8^{th} frame or more frequently.

In block 203, the HO controller 31 evaluates the link quality and the procedure is branched off based on the result of evaluation. If it is determined in block 203 that the link quality at the smaller cell 124 is sufficient (e.g. link quality, such as SINR, is above a predetermined threshold) and the MS 10 wants to scan the neighboring BSs (e.g. by a MOB_SCN-REQ message of the WiMAX standard), the BS 24 should deny this by indicating a zero time interval for scanning in block 204 (e.g. by a MOB_SCN-RSP message of the WiMAX standard).

If it is determined in block 203 that the link quality exceeds a threshold which indicates that it would be good to start considering handover, the BS 24 may allocate scanning time for the MS 10 in block 205 (e.g. in the MOB_SCN-RSP message of WiMAX, which can be a response to MOB_SCN-REQ message but the BS 24 can also send this message in an unsolicited fashion). This provides a good backup-list of potential target-BSs for HO in case the HO to the primary target-BS would fail for some reason.

Finally, if it is determined in block 203 that the link quality finally gets so poor that handover is preferred, the BS 24 may send an actual or full target list to the MS 10 in block 206 privately (e.g. in a MOB_BSHO-REQ message of WiMAX). If there are fresh scanning results available, then the list can contain only one neighboring BS (to avoid further scanning and delays).

It is noted that in some systems the terminal device (e.g. MS 10) may be able to do co-channel scanning without any separately allocated scanning time. In e.g. OFDMA-based systems this may be possible if there is a common physical channel shared by multiple cells so that they all use different OFDM-tones. The co-channel scanning can not be effectively prohibited—if the terminal wants to do it on the fly, there's no way to stop that from happening.

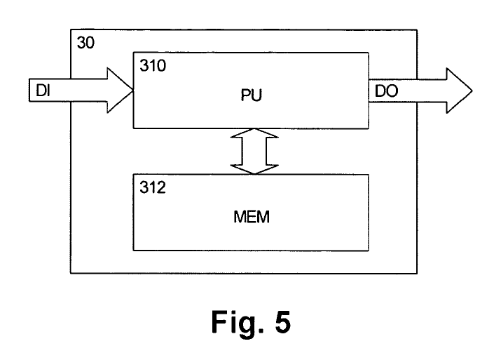

FIG. 5 shows a schematic block diagram of a software-based implementation of the proposed HO control mechanism according to the above embodiments. Here, the HO control apparatus 30 comprises a processing unit 310, which may be any processor or computer device with a control unit which performs control based on software routines of a control program stored in a memory 312. Program code instructions are fetched from the memory 312 and are loaded to the control unit of the processing unit 310 in order to perform the processing of the above functionalities described in connection with the respective FIGS. 2, 3, and 4. This processing may be performed on the basis of input data DI and may generate output data DO, wherein the input data DI may correspond to the link quality information 34 received from the MS 10 and the output data DO may correspond to the advertised HO control information 36 and/or the HO control messages 35.

The above embodiments provide better cell load balancing. No amendment to the standard is required, if the neighboring BSs are offered by the same vendor (as they typically are). If a neighboring BS does not understand the message the network remains operational even though performance may be worse. The additional HO activity by the MS can be offset by the improved interference performance of the cell.

To summarize, a method, computer program product, apparatus, and system for controlling handover of a terminal device have been described, wherein the terminal device is configured to select a handover target and initiate handover on its own, and wherein the terminal device is tied to at least one predetermined cell by performing network-sided control of available handover targets.

It is to be noted that the present invention is not restricted to the WiMAX-based embodiments described above, but can be implemented in any mobile network where HOs of mobile terminals can be at least party controlled by the network. Moreover, the invention is not limited to cell differentiation based on the cell size, i.e. ‘smaller’ and ‘larger’ cells. In an embodiment, smaller and larger cells may be originated from the same site (maybe even the same antenna), but this doesn't have to be the case. The cells may also partially overlap, e.g. a hotspot at a border of two large cells providing just coverage. Furthermore, a network with N same-size cells may be provided and the terminal device is just controlled for load balancing reasons when one of the cells gets close it's capacity limit. Also, the different embodiments described can be combined. The embodiments may thus vary within the scope of the attached claims.

1. A method comprising:
controlling handover of a terminal device in a cellular network by enabling said terminal device to select a handover target and initiate handover on its own; and
tying said terminal device to at least one predetermined cell by generating a network-sided control signaling to perform network-sided control of available handover targets.

2. The method according to claim 1, further comprising performing said network-sided control by controlling at least one neighboring handover target device located in proximity with an access device currently serving said terminal device, so that said at least one neighboring handover target device rejects a handover request from said terminal device.

3. The method according to claim 2, further comprising selecting as said at least one neighboring handover target device a target device which serves target cells different from a desired cell.

4. The method according to claim 2, further comprising performing said network-sided control by sending a handover command to said terminal device and by instructing said at least one neighboring handover target device to reject handover requests from said terminal device.

5. The method according to claim 4, wherein said instructing comprises distributing a tying message indicating at least one tied terminal device which should be served by a predetermined cell.

6. The method according to claim 4, further comprising performing said network-sided control by sending an end-of-tying message which indicates that tying of at least one tied terminal has ended.

7. The method according to claim 1, further comprising performing said network-sided control by estimating at least one of signal strength and signal quality for said terminal device when being served by a different cell, and by deciding about handover based on a threshold criterion.

8. The method according to claim 1, further comprising deciding about said handover based on a location information of said terminal device.

9. The method according to claim 7, further comprising selecting said threshold criterion to provide a hysteresis where a first threshold for admitting said terminal device is lower than a second threshold for releasing said terminal device.

10. The method according to claim 1, further comprising removing said tying if a handover has not been successful after a predetermined time period.

11. The method according to claim 1, further comprising performing said network-sided control by selecting an optimal tying cell from at least two cells which overlap at least partially.

12. The method according to claim 1, further comprising performing said network-sided control by advertising a reduced or empty list of neighboring access devices to said terminal device.

13. The method according to claim 12, further comprising performing said network-sided control by advertising said reduced or empty list as long as a determined link quality is above a first predetermined threshold, and by advertising a full list of neighboring access devices if said determined link quality falls below a second predetermined threshold.

14. The method according to claim 13, further comprising determining said link quality based on a measurement result received from said terminal device.

15. The method according to claim 1, further comprising performing said network-sided control by allocating a scanning time to said terminal device for scanning neighboring access devices, and by setting a duration of said scanning time in dependence on a determined link quality at said terminal device.

16. The method according to claim 15, wherein said scanning time is set to zero if said link quality exceeds a predetermined threshold.

17. An apparatus comprising a handover controller configured to generate a network-sided control signaling for controlling handover targets available to a terminal device of a cellular network, for tying said terminal device to at least one predetermined cell.

18. The apparatus according to claim 17, wherein said handover controller is configured to control at least one handover target device to reject a handover request from said terminal device.

19. The apparatus according to claim 18, wherein said handover controller is configured to select as said at least one handover target device a target device which serves target cells different from a desired cell.

20. The apparatus according to claim 18, wherein said handover controller is configured to send a handover command to said terminal device and to instruct said at least one handover target device to reject handover requests from said terminal device.

21. The apparatus according to claim 20, wherein said handover controller is configured to distribute a tying message indicating at least one tied terminal device which should be served by a predetermined cell.

22. The apparatus according to claim 20, wherein said handover controller is configured to distribute an end-of-tying message which indicates that tying of said terminal device has ended.

23. The apparatus according to claim 17, wherein said handover controller is configured to estimate at least one of signal strength and signal quality for said terminal device when being served by a different cell, and to decide about handover based on a threshold criterion.

24. The apparatus according to claim 17, wherein said handover controller is configured to decide about said handover based on a location information of said terminal device.

25. The apparatus according to claim 23, wherein said handover controller is configured to select said threshold criterion so as to provide a hysteresis where a first threshold for admitting said terminal device is lower than a second threshold for releasing said terminal device.

26. The apparatus according to claim 17, wherein said handover controller is configured to remove said tying if a handover has not been successful after a predetermined time period.

27. The apparatus according to claim 17, wherein said handover controller is configured to select an optimal tying cell from at least two cells which overlap partially.

28. The apparatus according to claim 17, wherein said handover controller is configured to advertise a reduced or empty list of neighboring access devices to said terminal device.

29. The apparatus according to claim 28, wherein said handover controller is configured to advertise said reduced or empty list as long as a determined link quality is above a first predetermined threshold, and to advertise a full list of neighboring access devices if said determined link quality falls below a second predetermined threshold.

30. The apparatus according to claim 29, wherein said handover controller is configured to determine said link quality based on a measurement result received from said terminal device.

31. The apparatus according to claim 28, wherein said handover controller is configured to allocate a scanning time to said terminal device for scanning neighboring access devices, and to set the duration of said scanning time in dependence on a determined link quality at said terminal device.

32. The apparatus according to claim 31, wherein said handover controller is configured to set said scanning time to zero if said link quality exceeds a predetermined threshold.

33. An apparatus comprising handover control means configured to generate a network-sided control signaling for controlling handover targets available to a terminal device of a cellular network, so as to tie said terminal device to at least one predetermined cell.

34. A system comprising:
an apparatus including a handover controller configured to generate a network-sided control signaling for controlling handover targets available to a terminal device of a cellular network, so as to tie said terminal device to at least one predetermined cell; and
at least one terminal device configured to select a handover target and initiate handover on its own.

35. A machine readable medium having instructions stored thereon, the instructions, when executed on a computing device provide for:
controlling handover of a terminal device in a cellular network by enabling said terminal device to select a handover target and initiate handover on its own; and
tying said terminal device to at least one predetermined cell by performing network-sided control of available handover targets.
